(19) United States
(12) Patent Application Publication
(10) Pub. No.: US 2003/0174600 A1
(43) Pub. Date: Sep. 18, 2003

(54) Tilt control device for optical disk and tilt control method

(75) Inventor: Tadafumi Yoshimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electronic Co., Ltd.

(21) Appl. No.: 10/365,542

(22) Filed: Feb. 13, 2003

(30) Foreign Application Priority Data
Feb. 25, 2002 (JP) P2002-047319

(51) Int. Cl. G11B 7/095

(52) U.S. Cl. 369/44.32; 369/53.19

(57) ABSTRACT

At the initialization, a tilt mechanism 9 is activated in a state where an optical pick-up 3 is fixed, and set up at a position where the level of a focus error signal obtained from an output of the optical pick-up 3 is at minimum. Thereafter, a reproducing operation is started. During the reproducing operation, the tilt mechanism 9 is not activated and the focus control is made with the focus servo by moving the optical pick-up 3 up or down, while the level of focus error signal is within a certain range. Further, if the level of focus error signal is beyond the certain range because the optical disk 1 is greatly inclined, the tilt mechanism 9 is activated to cause the optical disk 1 to come closer to the optical pick-up 3 to enable the control of the focus servo.

### BACKGROUND OF THE INVENTION

The present invention relates to a tilt control device for correcting the inclination of an optical disk in the DVD player or the like, and a tilt control method.

The DVD player or CD player is provided with an optical pick-up for reading the information recorded on the optical disk by applying a light beam onto the optical disk. If the optical disk is inclined due to plane deflection or warp, the light beam from the optical pick-up is applied obliquely onto the optical disk, and a reflected light is also obliquely directed to the optical pick-up. As a result, the optical pick-up cannot receive a part of the reflected light to reproduce a signal correctly. Particularly, the DVD player having a high recording density of disk and a small diameter of light beam is greatly affected by the inclination of disk, so that a correct reproduced signal can not be obtained even with a slight inclination. Thus, to eliminate this nonconformity, it is conventionally commonly practiced that a swingable tilt mechanism is provided to correct the inclination of disk.

FIG. 5 is a schematic diagram showing the tilt control device in the conventional DVD player. 11 denotes an optical disk such as DVD or CD, 12 denotes an optical pick-up for reading the information recorded on the optical disk by applying a light beam onto the optical disk 11, 13 denotes a tilt sensor for optically sensing the inclination of the optical disk 11, 14 denotes a tilt control portion for controlling a tilt motor 15 on the basis of a sensed output of the tilt sensor 13, and 16 denotes a tilt mechanism that is activated by the tilt motor 15. If the optical disk 11 is inclined, the tilt sensor 13 senses the amount of inclination (tilt amount) to send a sensed signal to the tilt control portion 14. The tilt control portion 14 drives the tilt motor 15 on the basis of the sensed signal, so that the tilt mechanism 16 is swung at a predetermined angle by the tilt motor 15. As a result, the optical disk 11 has its attitude corrected in response to swinging of the tilt mechanism 16 to correct the inclination of optical disk so that an illuminating light from the optical pick-up 12 is incident vertically upon the optical disk 11.

However, in the conventional tilt control device, the tilt sensor 13 is provided, apart from the optical pick-up 12, to detect the amount of inclination of the optical disk 11, whereby a separate component of the tilt sensor 13 is needed and there is a drawback that the cost is increased. Further, since the optical pick-up 12 and the tilt sensor 13 are unmatched in position, an error occurs in detecting the amount of inclination, resulting in a problem that the tilt control may not be correctly made.

Thus, noting that without the use of the tilt sensor, the light beam is unfocused on the optical disk if the disk is inclined, a tilt control device for making the tilt control was offered in which an electric current for driving a focus actuator in the optical pick-up is detected, and the amount of inclination of the optical disk is detected based on this electric current (the Unexamined Japanese Patent Application Publication No.2000-36125). However, in a servo control IC, because a drive current of the focus actuator is not usually monitored, it is difficult to take out this current on the circuit, whereby the IC with a signal terminal of drive current must be developed separately to take out this current. Further, in the tilt control device as disclosed in the above patent, there is a need for a circuit that converts current into voltage, resulting in a complex circuit configuration. Moreover, to make the tilt operation by detecting correctly the amount of inclination of the optical disk, while reproducing the optical disk, it is required to set up a reference position of the tilt prior to reproducing the optical disk. However, no description of this point is made in the above patent.

### SUMMARY OF THE INVENTION

The present invention is achieved in the light of the above-mentioned problems, and it is an object of the invention to provide a tilt control device that can be simply realized without greatly changing a circuit and make the correct tilt operation while reproducing the optical disk.

A tilt control device according to the present invention performs the tilt control using a focus error signal. Namely, at the initialization, the tilt mechanism is setup at a position where the level of the focus error signal obtained from an output of the optical pick-up is at minimum by driving the tilt motor in a fixed state of the optical pick-up. Thereafter, the reproducing operation is started. During the reproducing operation, the tilt mechanism is not activated and the focus control is made with the focus servo by moving the optical pick-up up or down, while the level of focus error signal is within a certain range. Further, if the level of focus error signal is beyond the certain range because the optical disk is greatly inclined, the tilt mechanism is activated to cause the optical disk to come closer to the optical pick-up to enable the focus servo.

In this manner, the focus error signal is employed as means for detecting the inclination of the optical disk, whereby the tilt sensor is dispensed with. Since the focus error signal is usually monitored, easily taken out on the circuit, and a voltage signal, it is unnecessary to provide a voltage conversion circuit, and greatly change or add the conventional circuit. At the initialization, the tilt mechanism is setup at a position where the level of focus error signal is at minimum, this position being defined as a reference position of tilt, so that the inclination of disk can be correctly detected on the basis of the focus error signal, while reproducing the optical disk, whereby the tilt operation can be reliably made.

In this invention, at the initialization, the optical pick-up is moved to the outer peripheral side of the optical disk, whereby the reference position of tilt is set up. In this manner, the reference position is set up on the outer peripheral side of the disk with more amount of displacement in the vertical direction due to inclination, and can be set up more correctly than on the inner peripheral side where the amount of displacement is small.

Further, in this invention, at the initialization, the reference position of tilt is set up in the state where the optical pick-up is fixed at the intermediate position in the vertical movement range. In this manner, even if the optical disk is displaced up or down from the reference position in reproduction, the optical pick-up can be moved up or down, following the optical disk, whereby the stable focus servo operation is made.

### BRIEF DESCRIPTION OF THE DRAWINGS

FIG. 1 is a block diagram of a tilt control device according to the present invention.

FIG. 2 is a flowchart showing the operation of the device of FIG. 1.

FIGS. 3A to 3D are views for explaining the tilt operation.

FIG. 4 is a view for explaining a movement range of the optical pick-up.

FIG. 5 is a schematic diagram of the conventional tilt control device.

### DETAILED DESCRIPTION OF THE PREFERRED EMBODIMENTS

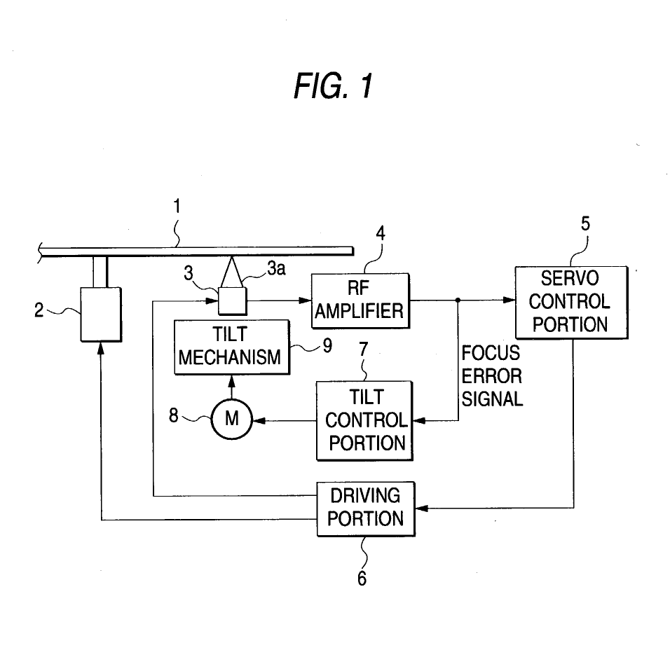

FIG. 1 is a block diagram of a tilt control device according to an embodiment of the present invention. In FIG. 1, 1 denotes an optical disk such as DVD or CD, 2 denotes a disk motor for rotating the optical disk 1, 3 denotes an optical pick-up for reading the information recorded on the optical disk by applying a light beam 3a onto the optical disk 1, 4 denotes an RF amplifier for outputting a focus error signal or a tracking error signal on the basis of a light received output of the optical pick-up 3, 5 denotes a servo control portion for controlling the operation of a focus servo or tracking servo on the basis of a signal from the RF amplifier 4, and 6 denotes a driving portion for driving the disk motor 2 and the optical pick-up 3 by receiving a signal from the servo control portion 5. The above constitution is not different from that provided for the conventional optical disk device. 7 denotes a tilt control portion for correcting the inclination of the optical disk 1 on the basis of a focus error signal from the RF amplifier 4, 8 denotes a tilt motor that is driven on the basis of an output signal from the tilt control portion 7, and 9 denotes a tilt mechanism that is swung by rotation of the tilt motor 8 to adjust the inclination of the optical disk 1.

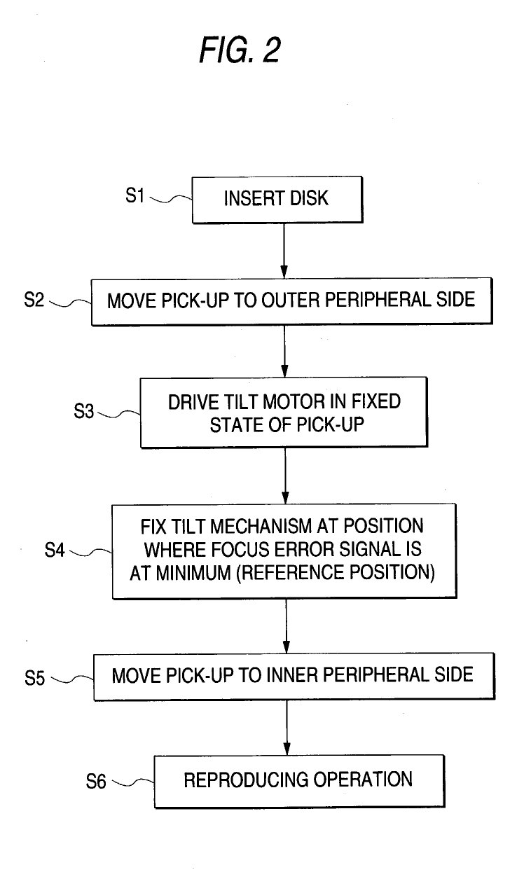

The operation of the tilt control device of FIG. 1 will be described below. FIG. 2 is a flowchart showing a procedure for a series of operations. At first, the optical disk 1 is inserted into a disk insertion slot (not shown) of the disk player (step S1). If the optical disk 1 is inserted, the initialization is made at steps S2 to S4. Then, the procedure goes to steps S5 and S6 to start the normal reproducing operation. The operation of each of steps S2 to S6 is controlled by a system controller, not shown in FIG. 1.

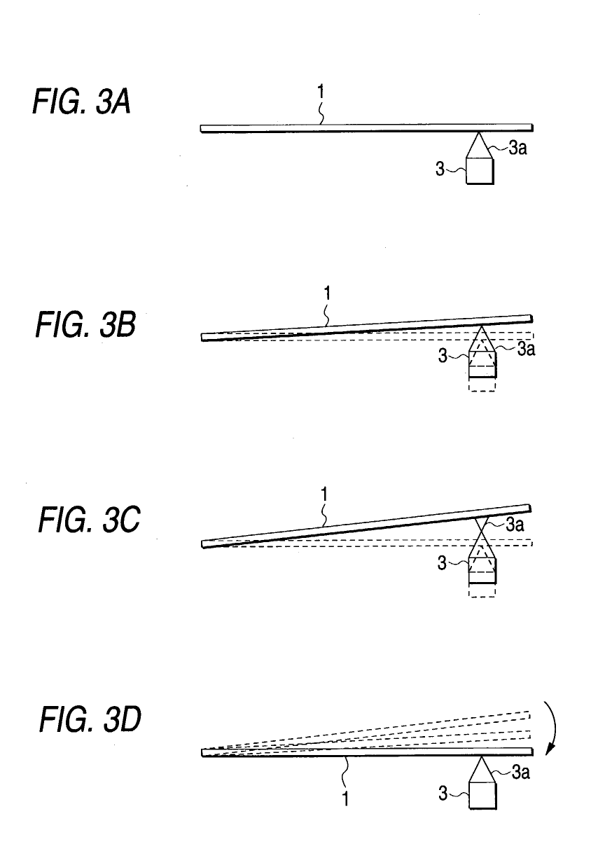

First of all, the operation at the initialization will be described below. If the optical disk 1 is inserted, the optical pick-up 3 is moved to the outer peripheral side (right side in FIG. 1) of the optical disk 1, and stopped near the outer periphery (step S2). At this position, the optical pick-up 3 is placed in a fixed state without vertical movement, and the tilt motor 8 is driven by the tilt control portion 7 (step S3). If the tilt motor 8 is operated, the tilt mechanism 9 linked with the motor is swung, and the amount of inclination of the optical disk 1 is changed correspondingly. In this state, if a light beam 3a is applied from the optical pick-up 3 onto the optical disk 1, the level of the focus error signal output from the RF amplifier 4 is varied in accordance with the amount of inclination of the optical disk 1. Thus, the position where the level of the focus error signal is at minimum (theoretically zero) is detected by the tilt control portion 7. At this position, the tilt motor 8 is stopped to fix the tilt mechanism 9 (step S4). The focus error signal at minimum means that the light beam 3a correctly forms a focal point on the optical disk 1 and the optical disk 1 is in vertical state to the optical axis of the optical pick-up 3. Thereby, the positional relation between the optical pick-up 3 and the optical disk 1 is set optimally at this position. Thus, this position is defined as a reference position of tilt. FIG. 3A is a view showing the positional relation between the optical disk 1 and the optical pick-up 3 at the reference position. After the reference position of tilt is set up in this way, the optical pick-up 3 is moved to the inner peripheral side (left side in FIG. 1) of the optical disk 1 (step S5), and the normal reproducing operation is performed (step S6).

The tilt control in the reproducing operation at step S6 will be described below. The tilt control portion 7 always monitors the level of focus error signal during the reproducing operation. The tilt mechanism 9 is not activated even if the optical disk 1 is inclined, while the level is within a certain range, whereby the ordinary focus servo control is made. That is, if the optical disk 1 is inclined as shown in FIG. 3B, a focus error signal at a level corresponding to the amount of inclination is output from the RF amplifier 4. However, in the case of FIG. 3B, because the amount of inclination of the disk is small and the level of focus error signal is low, the tilt control portion 7 does not drive the tilt motor 8 to activate the tilt mechanism 9. In this case, the servo control portion 5 drives the optical pick-up 3 via the driving portion 6 vertically in accordance with the focus error signal, and makes the adjustment so that the focus error signal is minimized. Accordingly, even if the tilt mechanism 9 is not activated, the optical pick-up 3 can follow the inclination of the optical disk 1 owing to the focus servo.

On the other hand, if the level of focus error signal goes beyond the certain range, the tilt mechanism 9 is operated to correct the inclination of the optical disk 1. That is, since the optical pick-up 3 has a limited vertical movement range, if the optical disk 1 is greatly inclined due to vibration or shock as shown in FIG. 3C, the optical pick-up 3 can not follow the inclination of the optical disk to disable the control of the focus servo. In this case, the tilt control portion 7 controls the tilt motor 8 to swing the tilt mechanism 9 to cancel the inclination of the optical disk 1. As a result, the optical disk 1 is displaced in a direction closer to the optical pick-up 3, as shown in FIG. 3D. If the optical disk 1 is displaced to a range where the focus servo of the servo control portion 5 is operative, the optical pick-up 3 can follow the inclination of the optical disk 1 due to the focus servo in the same manner as in FIG. 3B.

In the embodiment as. above described, the focus error signal obtained from an output of the optical pick-up is employed, instead of the tilt sensor, as detecting means for detecting the inclination of the optical disk, whereby the tilt sensor is dispensed with and the cost is lowered. The focus error signal from the RF amplifier 4 is easily taken out of the signal terminal for monitor without need for making special contrivances in the circuit. Further, the voltage conversion circuit is unnecessary because this focus error signal is a voltage signal.

At the initialization, the reference position of tilt is set up at the position where the level of focus error signal is at minimum. Hence, it is possible to detect correctly the inclination of the optical disk 1 from the reference position by detecting the level of focus error signal output from the RF amplifier 4 in reproduction. Accordingly, if a threshold is set for the level of detected signal, the tilt operation can be reliably made by activating the tilt mechanism 9 when the level of focus error signal exceeds the threshold because the optical disk 1 is inclined beyond a certain amount.

In the above embodiment, at the initialization, the optical pick-up 3 is moved to the outer peripheral side of the optical disk 1, whereby the reference position of tilt is set up near the outer periphery. Since the optical disk has a larger amount of vertical displacement due to inclination on the outer peripheral side than the inner peripheral side, the reference position is set up near the outer periphery with larger amount of displacement more accurately than on the inner peripheral side with smaller amount of displacement.

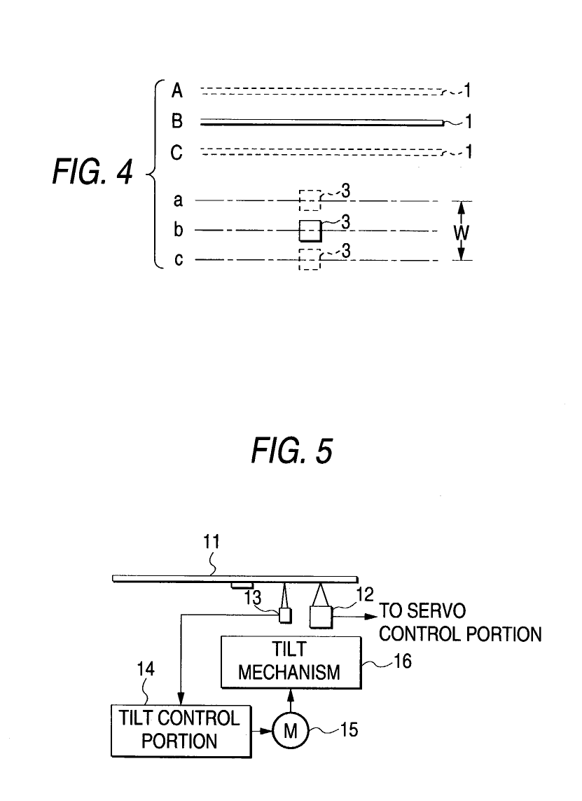

When the optical pick-up 3 is placed in a fixed state in setting the reference position, it is preferable that the optical pick-up 3 is fixed at an intermediate position in the vertical movement range. That is, the optical pick-up 3 is moved up or down in a vertical movement range W, following the displacement of the optical disk 1, as shown in FIG. 4. However, if a reference position A is set up in a state where the optical pick-up 3 is fixed at an upper limit position a, the optical pick-up 3 can not be displaced above the upper limit position a, when the optical disk 1 is displaced above the reference position A. Further, if a reference position C is set up in a state where the optical pick-up 3 is fixed at a lower limit position c, the optical pick-up 3 can not be displaced under the lower limit position c, when the optical disk 1 is displaced under the reference position C. Thus, if a reference position B is set up in a state where the optical pick-up 3 is fixed at the intermediate position b in the vertical movement range W, the optical pick-up 3 is displaced above or under the reference position B to follow the optical disk, when the optical disk 1 is displaced above or under the reference position B, whereby the stable focus servo operation can be obtained.

In the above embodiment, after the optical disk 1 is displaced by tilt operation to the range where the focus servo possible, the optical pick-up 3 is caused to follow the optical disk 1 owing to the focus servo. However, the optical disk 1 may be displaced only by tilt operation till the level of focus error signal is at minimum.

Further, in the above embodiment, the tilt motor 8 is employed as the driving means for driving the tilt mechanism 9, but other driving means than the motor may be employed.

With this invention, the tilt control is made using the focus error signal, whereby there is no need for the tilt sensor, and the tilt control can be simply implemented without greatly changing or adding the circuit. Since the reference position is set up at the position where the level of focus error signal is at minimum, the inclination of the optical disk can be correctly detected from the focus error signal in reproduction, whereby the tilt operation can be effected reliably.

What is claimed is:

1. A tilt control device for an optical disk comprising:
an optical pick-up for reading the information recorded on the optical disk by applying a light beam onto the optical disk,
a tilt mechanism for correcting an inclination of the
optical disk,
a tilt motor for activating said tilt mechanism,
detecting means for detecting the amount of inclination of the optical disk, and
a tilt control portion for controlling said tilt motor on the basis of the detection result of said detecting means, wherein
said detecting means involves the use of a focus error signal obtained from an output of said optical pick-up, instead of a tilt sensor,
at the initialization, said tilt mechanism is set up at a position where the level of the focus error signal is at minimum by driving said tilt motor under the control of said tilt control portion in a state where said optical pick-up is fixed at an intermediate position in a vertical movement range by moving said optical pick-up to the outer peripheral side of the optical disk, and a reproducing operation is started by moving said optical pick-up to the inner peripheral side of the optical disk;
during the reproducing operation, if the level of the focus error signal is within a certain range, said tilt control portion does not activate said tilt motor, and if the level of the focus error signal is beyond the certain range, said tilt control portion activates said tilt motor to control the optical disk to come closer to said optical pick-up in a range where the focus servo is possible.

2. A tilt control device for an optical disk comprising:
an optical pick-up for reading the information recorded on the optical disk by applying a light beam onto the optical disk,
a tilt mechanism for correcting an inclination of the optical disk, and
a tilt control portion for controlling said tilt mechanism, wherein
at the initialization, said tilt mechanism is set up at a position where the level of a focus error signal obtained from an output of said optical pick-up is at minimum by activating said tilt mechanism under the control of said tilt control portion in a state where said optical pick-up is fixed, and a reproducing operation is started;
during the reproducing operation, if the level of the focus error signal is within a certain range, said tilt control portion does not activate said tilt mechanism, and if the level of the focus error signal is beyond the certain range, said tilt control portion activates said tilt mechanism to control the optical disk to come closer to said optical pick-up.

3. The tilt control device for optical disk according to claim 2, wherein
said optical pick-up is moved to the outer peripheral side of the optical disk at the initialization.

4. The tilt control device for optical disk according to claim 2, wherein
said optical pick-up is fixed at an intermediate position in a vertical movement range at the initialization.

5. A tilt control method for an optical disk comprising the steps of:
at the initialization, moving said optical pick-up to the outer peripheral side of the optical disk;
setting up a tilt mechanism at a position where the level of the focus error signal is at minimum by driving a tilt motor under the control of a tilt control portion in a state where said optical pick-up is fixed at an intermediate position in a vertical movement range;
starting a reproducing operation by moving said optical pick-up to the inner peripheral side of the optical disk;
during the reproducing operation, if the level of the focus error signal is within a certain range, not activating said tilt motor by said tilt control portion, and if the level of the focus error signal is beyond the certain range, activating said tilt motor by said tilt control portion to control the optical disk to come closer to said optical pick-up in a range where the focus servo is possible.

6. A tilt control method for an optical disk comprising the steps of:
at the initialization, setting up a tilt mechanism at a position where the level of a focus error signal obtained from an output of an optical pick-up is at minimum by activating a tilt motor under the control of said tilt control portion in a state where said optical pick-up is fixed;
starting a reproducing operation;
during the reproducing operation, if the level of the focus error signal is within a certain range, not activating said tilt mechanism by said tilt control portion, and if the level of the focus error signal is beyond the certain range, activating said tilt mechanism by said tilt control portion to control the optical disk to come closer to said optical pick-up.

7. The tilt control method for optical disk according to claim 6, further comprising:
moving said optical pick-up to the outer peripheral side of the optical disk at the initialization.

8. The tilt control device for optical disk according to claim 6, further comprising:
fixing said optical pick-up at an intermediate position in a vertical movement range at the initialization.
